(19) United States
(12) Patent Application Publication
(10) Pub. No.: US 2019/0337432 A1
(43) Pub. Date: Nov. 7, 2019

(54) VEHICLE SEATING SYSTEM

(71) Applicant: LEAR CORPORATION, Southfield, MI (US)

(72) Inventors: Rodger Gordon SMITH, Shropshire (GB); Miroslav SAMUDOVSKY, Coventry (GB)

(21) Appl. No.: 15/968,873

(22) Filed: May 2, 2018

(51) Int. Cl. B60N 2/70; B60N 2/58

(52) U.S. Cl. CPC B60N 2/7011; B60N 2/5816; B60N 2/7017

(57) ABSTRACT

A system and method for producing a vehicle seating system includes a frame structure and a cushion positioned in the frame structure. A suspension mat is positioned along a back side of the cushion, and a securing arrangement extends across a width of the cushion such that the suspension mat is positioned between the securing arrangement and the back side of the cushion. The securing arrangement further extends into the cushion and attaches to the anchor which may inhibit dislocation of the cushion from the suspension mat.

### TECHNICAL FIELD

The present disclosure relates to a vehicle seating system.

### BACKGROUND

Vehicle seating systems may comprise many different components and subsystems that work together so that the seating system provides both the desired functionality and aesthetic appearance. Some vehicle seating systems have a seat cushion made from a foam or other material supported on a frame or other support structure, and may be surrounded by a trim cover. The trim cover may be made from a cloth, leather, or other material. In order to provide an aesthetically pleasing appearance, the trim cover may be wrapped tightly around an outside of the seat cushion. In some cases, this may deform the seat cushion or move it out of position relative to a seat support structure. It would therefore be desirable to have a vehicle seating system and method that facilitates maintaining components of the seating system in desired positions when the seating system is assembled.

### SUMMARY

At least some embodiments described herein may include a vehicle seating system having a frame structure and a cushion positioned in the frame structure. The cushion has a front side and a back side, and may include an anchor embedded therein. A suspension mat is positioned along the back side of the cushion, and a securing arrangement extends across a width of the cushion such that the suspension mat is positioned between the securing arrangement and the back side of the cushion. The securing arrangement further extends into the cushion, attaches to the anchor, and inhibits dislocation of the cushion from the suspension mat.

At least some embodiments described herein may include a vehicle seating system having a cushion with a front side and a back side, and an anchor embedded therein. An elastic support may be positioned adjacent to the back side of the cushion. The vehicle seating system may also include a securing arrangement having a portion positioned on an outside of the elastic support and another portion positioned inside the cushion and attached to the anchor such that the elastic support is captured between the securing arrangement and the back side of the cushion.

At least some embodiments described herein may include a method for producing a vehicle seating system that includes the step of positioning an anchor within a cushion having a front side and a back side. An elastic support may be positioned adjacent to the back side of the cushion. In addition, a first portion of a securing arrangement may be positioned on an outside of the elastic support such that the elastic support is captured between the securing arrangement and the back side of the cushion. A second portion of the securing arrangement may be positioned within the cushion, and the second portion of the securing arrangement may be attached to the anchor.

### BRIEF DESCRIPTION OF THE DRAWINGS

FIG. 1 shows a portion of a seating system having a seat cushion, and elastic support structure, and a securing arrangement in accordance with embodiments described herein;

FIG. 2 shows a partial cross-sectional view of the seating system taken through lines 2-2 shown in FIG. 1; and

FIG. 3 shows a partial cross-sectional front perspective view of the seating system shown in FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

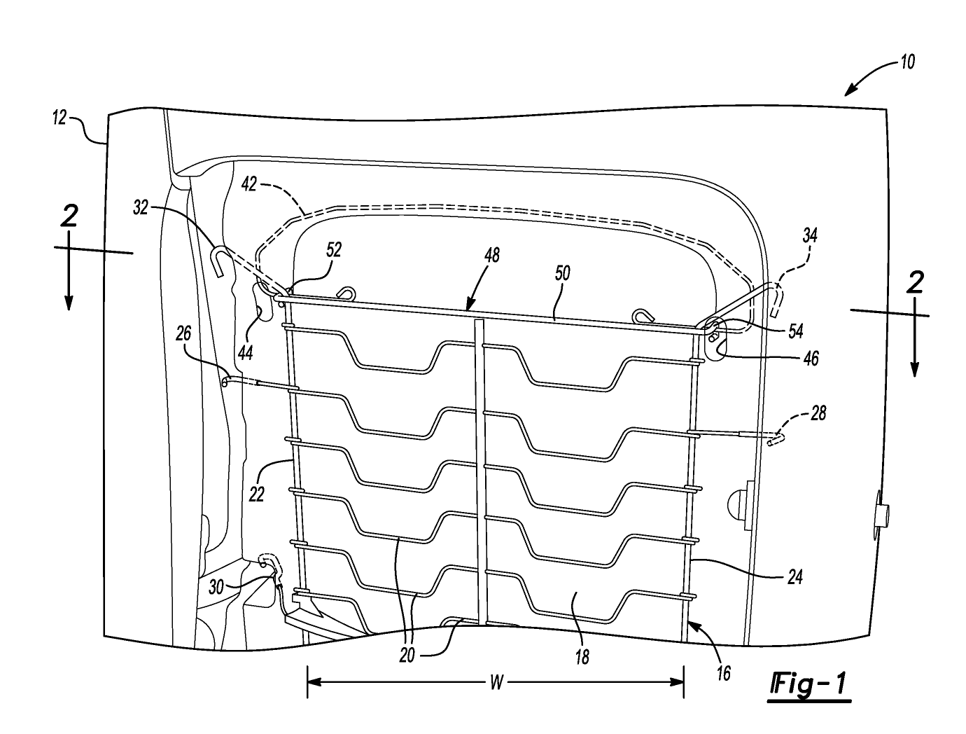

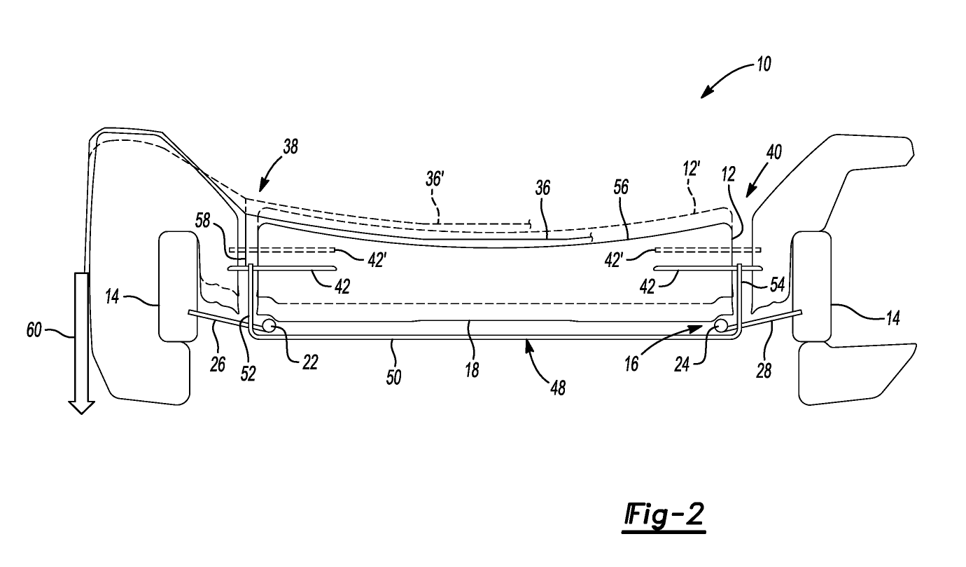

FIG. 1 shows a portion of a seating system 10 that includes a seat cushion 12, which in this embodiment is a part of a seat back of the seating system 10. Other embodiments may have a similar, or the same, structure as shown in FIG. 1 applied to a cushion for a seat bottom. The seat cushion 12 may be made from a polymeric foam material, or some other cushion material that provides the desired properties—e.g., support and comfort—for a seated occupant. The seat cushion 12 is positioned in, attached to, or otherwise supported by a seat support structure, such as a frame structure 14—see FIG. 2. In addition to the frame structure 14, the seat cushion 12 is also supported by an elastic support, which in this embodiment, is a flexible suspension mat 16.

The suspension mat 16 is positioned along a back side 18 of the seat cushion 12. It includes a number of horizontal wire supports 20, only some of which are labeled in FIG. 1 for clarity. The suspension mat 16 also includes two vertical wire supports 22, 24. Attached to the wire supports 22, 24 are several attachment features 26, 28, 30 in the form of hooks that may be attached to a seat support structure, such as the frame structure 14 shown in FIG. 2. In the embodiment shown in FIG. 1, the wire supports 22, 24 themselves have respective end hooks 32, 34, which may also be attached to a seat support structure, such as the frame structure 14.

As shown in FIG. 2, the seat cushion 12 may have a trim cover material 36 positioned around its outside surface. In order to provide an aesthetically pleasing appearance, the trim material may be tucked into certain portions 38, 40 of the seat cushion 12, and may be wrapped tightly around the outside and securely anchored. One way that a trim cover material can be tucked into a seat cushion so that it remains within a crevice of the seat cushion, is to anchor the trim material to a support structure inside the seat cushion. As shown in FIGS. 1 and 2, the seat cushion 12 includes an anchor, which in this embodiment is a trim wire 42 embedded in the seat cushion 12. The trim wire 42 may be, for example, molded in the seat cushion 12 if it is a molded foam material. In such a configuration, the trim wire 42 may be held in place in a mold by magnetic locators that leave openings 44, 46 in the backside 18 of the cushion 12.

FIG. 1 also shows a securing arrangement 48 that inhibits dislocation of the cushion 12 from the suspension mat 16, particularly when a trim cover material, such as the trim cover 36, is attached to the cushion 12. The securing arrangement 48 extends across a width (W) of the cushion 12 that is generally bounded by the vertical wire supports 22, 24, which effectively define a left edge and a right edge, respectively, of the suspension mat 16. The securing arrangement 48 includes a portion, which in this embodiment is an elongated member 50, that is positioned on an outside of the suspension mat 16. The securing arrangement 42 also includes another portion, which in this embodiment consists of two legs 52, 54, positioned at least partly inside the cushion 12. As shown in FIG. 1, the securing arrangement 48 is positioned such that the suspension mat 16 is captured between the securing arrangement 48 and the back side 18 of the cushion 12.

In the embodiment shown in FIG. 1, the securing arrangement 48 is made from a relatively stiff, heavy-gauge wire. Although the wire material may be metal, other materials may also be used. As described in more detail below, having a relatively stiff, relatively inflexible structure for a securing arrangement, such as the securing arrangement 48, may keep the seat cushion 12 from deforming or otherwise dislocating from the suspension mat 16 when a trim cover is installed.

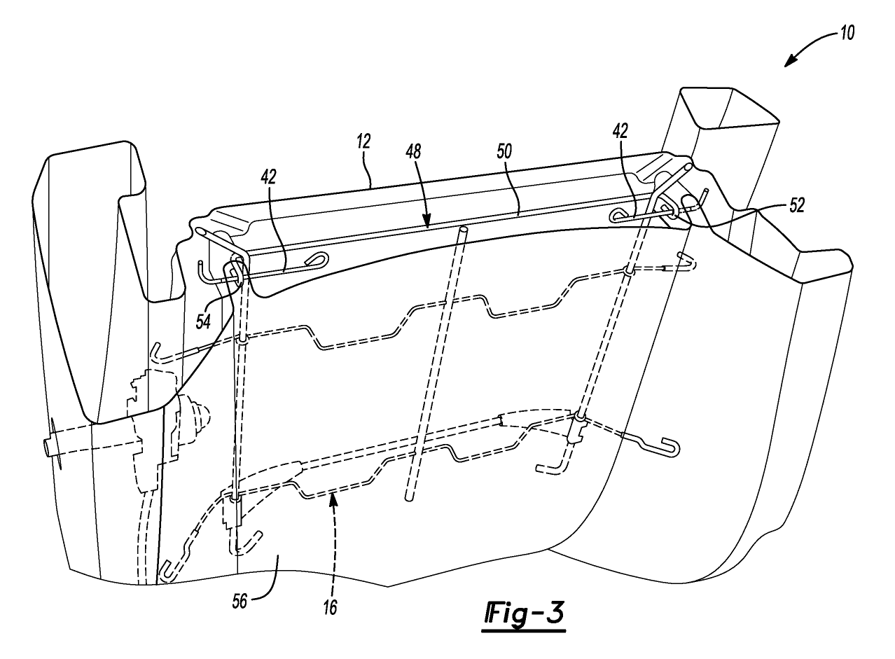

FIG. 3 shows the seating system 10 from a front side 56 of the seat cushion 12. As shown in FIG. 3, the two legs 52, 54 of the securing arrangement 48 extend into the cushion 12 and attach to the trim wire 42 from the back side 18 of the cushion 12. More specifically, the elongated portion 50 of the securing arrangement 48 is positioned on an outside of the suspension mat 16. The legs 52, 54 are positioned beyond the left and right edges of the suspension mat 16—in this embodiment, the vertical wire supports 22, 24—and further, are positioned at least partly inside the cushion 12 where they are attached to the anchor wire 42. This arrangement inhibits dislocation of the cushion 12 from the suspension mat 16.

Returning to the cross-sectional view of the seating system 10 shown in FIG. 2, the effect of wrapping a trim cover tightly around a seat cushion is illustrated. The solid lines and numbers show the trim cover 36 wrapped around the seat cushion 12 with the securing arrangement 48 installed as illustrated and described above. As shown in FIG. 2, the securing arrangement 48 wraps around an outside of the suspension mat 16 and attaches to the trim wire 42. This captures the suspension mat 16 between the securing arrangement 48 and the back side 18 of the cushion 12. The trim cover 36 wraps around the cushion 12 and attaches to the trim wire 42 from the front side 56 with a hog ring 58 or other fastening arrangement at an attachment point adjacent to the leg 52 of the securing arrangement 48. In FIG. 2, this is illustrated on the left side of the seat cushion 12 only.

When the trim cover 36 is installed around the seat cushion 12, it may be desirable to wrap it tightly around the seat cushion 12 to provide a more functional and aesthetically pleasing assembly. As shown in FIG. 2 by the direction arrow 60, a portion of the trim cover 36 is pulled along the left edge of the seat cushion 12 in a direction generally from the front side 56 toward the backside 18. In practice, this may simultaneously take place along the right side of the seat cushion 12 as well. The components in FIG. 2 shown in phantom and labeled with the prime (′) represent the seating system 10 when a securing arrangement, such as the securing arrangement 48 is not used.

Because the trim cover 36 is attached to the trim wire 42, a large tensile force applied to the trim cover 36 as shown by the direction arrow 60 may cause a large tensile force to be applied to the trim wire 42 in direction generally toward a front of the seating system 10. This in turn may cause the cushion 12 to be pulled in a forward direction, thereby deforming it or otherwise dislocating it from the suspension mat 16—see the seat cushion 12′ and the trim wire 42′.

As described above, the securing arrangement 48 may serve number of functions, including keeping the suspension mat 16 secured to the back side 18 of the cushion 12, and keeping the cushion 12 from moving forward relative to the suspension mat 16, the frame 14, or both. In other embodiments, a securing arrangement, such as the securing arrangement 48 may be made from a relatively flexible material, and in some embodiments an elastic material may be used. In these embodiments, the cushion 12 may move somewhat forward in the presence of a tension applied to the trim cover 36—at least relative to the frame structure 14—but the elastic securing arrangement may still keep the suspension mat 16 positioned immediately adjacent the back side 18 of the cushion 12.

An example of a method for producing a vehicle seating system, and in particular, one that includes a securing arrangement such as described above, is now described. A vehicle seat cushion may include a cushion for a seat back, a cushion for a seat bottom, or both. Any of a number of different materials may be used to produce the cushion, such as urethane, polyurethane, or other polymeric or plant-based foam materials. Non-foam materials may also be used to produce a seat cushion, depending on the desired and required properties. Because many seat cushions are covered with a trim cover material, and the trim cover material is often anchored at one or more locations inside the cushion, a method for producing a vehicle seating system may include the step of positioning an anchor—for example, a trim wire—within a seat cushion. An example of this is illustrated in Figures in 1-3 with the trim wire 42 embedded in the seat cushion 12.

The seat cushion may then be positioned adjacent and attached to a support structure, such as a seat frame or other support structure—see, e.g., the seat cushion 12 attached to the frame structure 14 in FIG. 2. It may also be desirable to have additional, flexible support associated with the seat cushion, and so an elastic support arrangement, such as a suspension mat, may be positioned adjacent to a back side of the cushion—see, e.g., the suspension mat 16 positioned along a back side 18 of the seat cushion 12. Although the steps described herein are provided in a particular order, in at least some cases the steps may occur in a different order, and not all of the steps—or additional steps—may be included.

Once the suspension mat is in its desired position, a securing arrangement, such as the securing arrangement 48 may be positioned on an outside of the suspension mat so that it is captured between the securing arrangement and the backside of the cushion—see, e.g., FIGS. 1 and 2. In particular, a first portion, such as the elongated portion 50, of the securing arrangement may be positioned across a width of the suspension mat, while a second portion, such as the legs 52, 54, may be positioned beyond the left and right edges of the suspension mat and attached to the trim wire at two separate locations within the seat cushion—see, for example, FIGS. 2 and 3.

After the securing arrangement is installed to maintain the position of the suspension mat relative to the back side of the cushion, a trim cover may be installed around an outside of the cushion. Where the trim cover is inserted into crevices in a front side of the cushion, it may be beneficial to attach it to an anchor, such as the trim wire, and in particular, attach it to the trim wire at a position very near the attachment of securing arrangement. The trim cover may be pulled around a side of the cushion in a generally rearward direction to apply a desired tension.

In embodiments having a securing arrangement made from a relatively stiff, relatively inflexible material, the cushion may experience little or no forward movement, and may maintain its desired position relative to the suspension mat. In other embodiments, where the securing arrangement is made from a more flexible material, the cushion may move forward somewhat in the presence of the tension applied to the trim cover, but the relative position of the cushion to the suspension mat may be maintained.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seating system comprising:
a frame structure;
a cushion positioned in the frame structure and having a front side and a back side, and including an anchor embedded therein;
a suspension mat positioned along the back side of the cushion; and
a securing arrangement extending across a width of the cushion such that the suspension mat is positioned between the securing arrangement and the back side of the cushion, the securing arrangement further extending into the cushion and attaching to the anchor and inhibiting dislocation of the cushion from the suspension mat.

2. The vehicle seating system of claim 1, further comprising a trim cover attached to the anchor from the front side of the cushion.

3. The vehicle seating system of claim 1, wherein the suspension mat has a width bounded by a left edge and a right edge, and the securing arrangement includes an elongated member extending across the left edge and the right edge on an outside of the suspension mat.

4. The vehicle seating system of claim 3, wherein the securing arrangement further includes two legs, each positioned beyond the respective left edge and right edge of the suspension mat.

5. The vehicle seating system of claim 4, wherein each of the legs of the securing arrangement is secured to the anchor from a back side of the cushion.

6. The vehicle seating system of claim 5, further comprising a trim cover attached to the anchor from the front side of the cushion.

7. The vehicle seating system of claim 6, wherein the trim cover is attached to the anchor adjacent to each of the legs of the securing arrangement.

8. A vehicle seating system comprising:
a cushion having a front side and a back side, and including an anchor embedded therein;
an elastic support adjacent the back side of the cushion; and
a securing arrangement having a portion positioned on an outside of the elastic support and another portion positioned at least partly inside the cushion and attached to the anchor such that the elastic support is captured between the securing arrangement and the back side of the cushion.

9. The vehicle seating system of claim 8, further comprising a frame structure, and wherein the cushion and the elastic support are attached to the frame structure.

10. The vehicle seating system of claim 8, wherein the elastic support has a width bounded by a left edge and a right edge, and the securing arrangement includes an elongated member extending across the left edge and the right edge on an outside of the elastic support.

11. The vehicle seating system of claim 8, wherein the elastic support has a width bounded by a left edge and a right edge, and the securing arrangement includes an elongated member and two legs, each positioned beyond the respective left edge and right edge of the elastic support.

12. The vehicle seating system of claim 11, wherein each of the legs of the securing arrangement is secured to the anchor from a back side of the cushion.

13. The vehicle seating system of claim 12, further comprising a trim cover attached to the anchor from the front side of the cushion.

14. The vehicle seating system of claim 13, wherein the trim cover is attached to the anchor adjacent to each of the legs of the securing arrangement.

15. A method for producing a vehicle seating system comprising:
positioning an anchor within a cushion having a front side and a back side;
positioning an elastic support adjacent the back side of the cushion;
positioning a first portion of a securing arrangement on an outside of the elastic support such that the elastic support is captured between the securing arrangement and the back side of the cushion;
positioning a second portion of the securing arrangement at least partly within the cushion; and
attaching the second portion of the securing arrangement to the anchor.

16. The method of claim 15, wherein positioning the first portion of the securing arrangement on the outside of the elastic support includes positioning an elongated member of the securing arrangement across a left edge and a right edge of the elastic support, and positioning the second portion of the securing arrangement within the cushion includes positioning two legs of the securing arrangement beyond the respective left edge and right edge of the elastic support.

17. The method of claim 16, wherein attaching the second portion of the securing arrangement to the anchor includes attaching the two legs to the anchor from a back side of the cushion.

18. The method of claim 17, further comprising positioning a trim cover over at least a portion of the cushion, and attaching the trim cover to the anchor from the front side of the cushion.

19. The method of claim 18, wherein attaching the trim cover to the anchor from the front side of the cushion includes attaching the trim cover to the anchor in two locations, each adjacent to one of the two legs of the securing arrangement.

20. The method of claim 15, further comprising positioning the cushion adjacent a seat frame, and attaching the elastic support to the seat frame.
